(19) United States
(12) Patent Application Publication
(10) Pub. No.: US 2026/0244773 A1
(43) Pub. Date: Aug. 20, 2026

(54) CROSS-INDUSTRY ADAPTIVE ACCESS CONTROL AND ASSET MANAGEMENT SYSTEM WITH PROOF-OF-EFFORT BLOCKCHAIN ARCHITECTURE

(71) Applicant: Interrupt21 LLC, Dacula, GA (US)

(72) Inventor: Maurice Jerome Witten, Dacula, GA (US)

(73) Assignee: Interrupt21 LLC, Dacula, GA (US)

(21) Appl. No.: 19/055,422

(22) Filed: Feb. 17, 2025

(51) Int. Cl. G06F 21/62; G06F 21/16; G06F 21/31; H04L 9/00; H04L 9/08; H04L 9/32

(52) U.S. Cl. CPC G06F 21/62; G06F 21/16; G06F 21/316; H04L 9/0852; H04L 9/3213; H04L 9/3221; H04L 9/3236; H04L 9/3247; H04L 9/50

(57) ABSTRACT

A system for adaptive access control and asset management comprises a metric collection layer configured to capture real-time user metrics from integrated systems. A blockchain layer provides an immutable, quantum-resistant ledger for storing access events, asset records, and compliance data. An authorization layer manages adaptive access control based on effort scores, access thresholds, and effort decay mechanisms. A data integration layer interfaces with external applications for data access, analytics, and reporting. The metric collection layer captures task completion, accuracy, and engagement metrics. The blockchain layer employs a hybrid model combining on-block and off-block storage. The authorization layer includes a BlockCipher Module for making access decisions based on calculated effort scores and predefined thresholds. The data integration layer facilitates integration of AI algorithms for behavior analysis and predictive insights. The system enables secure, adaptive access control and asset tracking across industries like finance, healthcare, supply chain, and government sectors.

### FIELD OF THE INVENTION

The present disclosure relates generally to access control and asset management systems, and more particularly to an adaptive, cross-industry framework for secure, effort-based access control and dynamic asset management utilizing a proof-of-effort blockchain architecture.

### BACKGROUND

As technology accelerates, the boundaries between human-driven decision-making and AI insights are becoming both less defined and more powerful. Traditional identity and access management (IAM) models, asset tracking systems, and compliance frameworks rely heavily on static, predefined credentials, role-based access, and standard multifactor authentication (MFA). While these methods aim to secure systems, they are often limited in their adaptability and their ability to integrate human intuition, continuous learning, and AI-driven strategy. Moreover, they face critical challenges as data security threats intensify and the quantum computing horizon renders many conventional cryptographic protections increasingly inadequate. The present disclosure addresses these and other issues.

### BRIEF OVERVIEW

Both the foregoing general description and the following detailed description are explanatory only and are not restrictive of the disclosure. Embodiments may be directed to various feature combinations and sub-combinations described in the detailed description. In one aspect, the present disclosure describes a cross-industry adaptive access control and asset management system with a proof-of-effort blockchain architecture. The system may provide a secure, adaptive, and cross-industry framework for access control and asset management that integrates human thought, strategy, and AI capabilities. In some embodiments, the system may include dynamic access control based on real-time user behavior and effort metrics. The system may also include blockchain-based asset tokenization and provenance tracking. Quantum-resistant data protection may be incorporated. The system may integrate AI for behavior analysis and anomaly detection. The system may have cross-industry applicability, including but not limited to finance, healthcare, supply chain, education, and the public sector.

It should be appreciated that this Brief Overview is provided to introduce a selection of concepts in a simplified form that are further described below in the Detailed Description. This Brief Overview is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure. The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example system architecture diagram showing the Metric Collection, Blockchain, Authorization, and Data Integration Layers, in accordance with some embodiments.

FIGS. 2A and 2B illustrates an example authentication workflow diagram depicting the steps for user login, metric retrieval, and real-time access decisions, in accordance with some embodiments.

FIG. 3 illustrates an example effort decay model flowchart demonstrating how user inactivity leads to decayed access levels, in accordance with some embodiments.

FIG. 4 illustrates an example asset tokenization workflow illustrating asset registration, lifecycle updates, and immutable provenance tracking, in accordance with some embodiments.

FIG. 5 illustrates an example API integration and data flow diagram visualizing how real-time metrics flow through the API Gateway and are used in access decisions, in accordance with some embodiments.

FIG. 6 is a block diagram of a system including a computing device for performing the various functions and methods disclosed herein.

FIG. 7 is a flowchart illustrating a data flow in the healthcare sector according to an embodiment of the present invention.

FIG. 8 is a flowchart illustrating a data flow in the finance sector according to an embodiment of the present invention.

FIG. 9 is a flowchart illustrating a data flow in the supply chain sector according to an embodiment of the present invention.

FIG. 10 is a flowchart illustrating a data flow in the aerospace sector according to an embodiment of the present invention.

FIG. 11 is a flowchart illustrating a data flow in the education sector according to an embodiment of the present invention.

FIG. 12 is a flowchart illustrating a data flow in the finance sector according to an embodiment of the present invention.

### DETAILED DESCRIPTION

The present disclosure includes many aspects and features. Moreover, while many aspects and features relate to, and are described in, the context of a cryptocurrency asset management platform providing cryptocurrency management, embodiments of the present disclosure are not limited to use only in this context. Before the present methods, systems, and apparatuses are disclosed and described, it is to be understood that they are not limited to specific methods unless otherwise specified, or to particular materials unless otherwise specified, as such may vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a cryptocurrency wallet” can include two or more cryptocurrency wallets. As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. The present disclosure describes various embodiments of a cross-industry adaptive access control and asset management system with a proof-of-effort blockchain architecture. The described system may provide a secure, adaptive, and cross-industry framework for access control and asset management that integrates human thought, strategy, and AI capabilities.

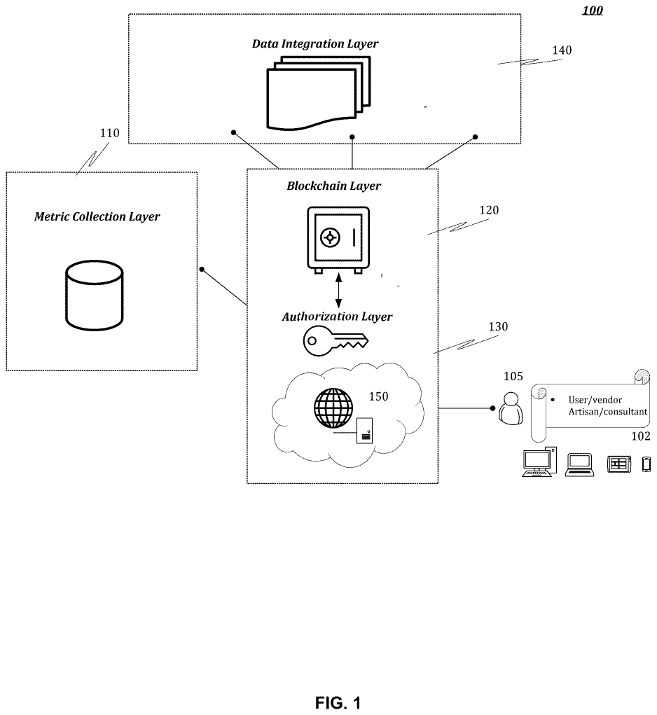

Referring now to FIG. 1, an example system architecture for the proof of effort platform 100 is illustrated. The system architecture for the proof of effort platform 100 may include four core layers: a Metric Collection Layer 110, a Blockchain Layer 120, an Authorization Layer 130 (which may include a BlockCipher Module), and a Data Integration Layer 140. The Metric Collection Layer 110 may capture real-time user metrics from integrated systems. These integrated systems may include, but are not limited to, Azure AD, Cisco, and other third-party applications. The metrics captured may include, for example, task completion, accuracy, engagement, and other behavioral indicators. The Blockchain Layer 120 may provide an immutable, quantum-resistant ledger for storing access events, asset records, and compliance data. This layer may employ a hybrid blockchain model, combining on-block and off-block storage to provide both immutable data integrity and efficient scalability. The Authorization Layer 130 may manage adaptive access control based on effort scores, access thresholds, and effort decay mechanisms. This layer may include the BlockCipher Module, which may be responsible for making access decisions based on the calculated effort scores and predefined thresholds. The Data Integration Layer 140 may interface with external applications for seamless data access, analytics, and reporting. This layer may facilitate the integration of AI algorithms for behavior analysis and predictive insights. A user 105 may include but is not limited to a user, vendor, artisan, laborer, consultant, and the like. The user 105 may access the platform 100 via user device 102 including but not limited to a computer, mobile device, laptop, tablet, desktop, and the like.

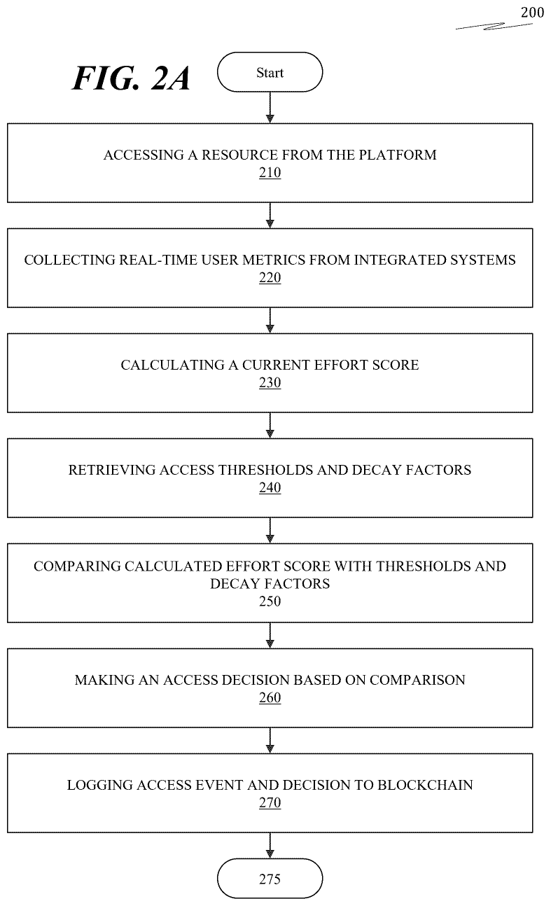

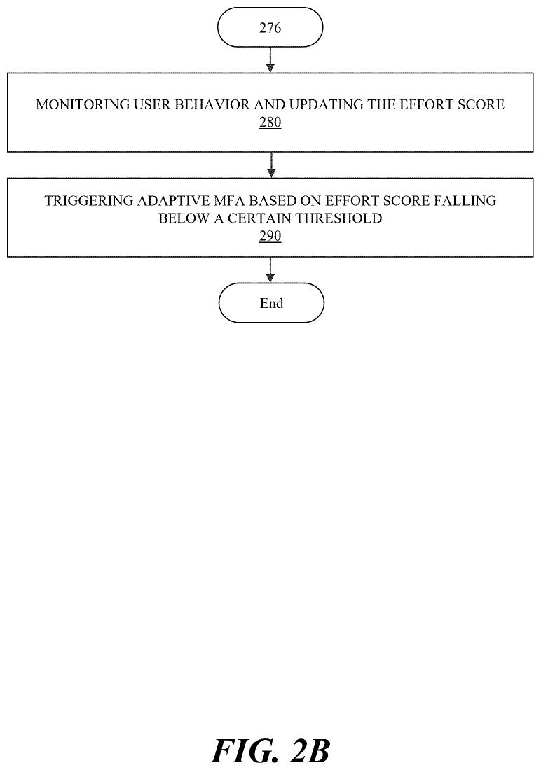

FIGS. 2A and 2B illustrates an example authentication workflow 200. The workflow may begin when a user attempts to access a resource within the system (step 210). The system may then collect real-time user metrics from integrated systems (step 220). Based on these metrics, the system may calculate a current effort score (step 230). The system may then retrieve access thresholds and decay factors from the blockchain (step 240). The calculated effort score may be compared to the retrieved thresholds, and decay factors may be applied (step 250). Based on this comparison, an access decision may be made (step 260). The access event and decision may be logged in the blockchain (step 270). The system may continuously monitor user behavior and update the effort score (step 280). If the effort score falls below a certain threshold, the system may trigger adaptive MFA (step 290).

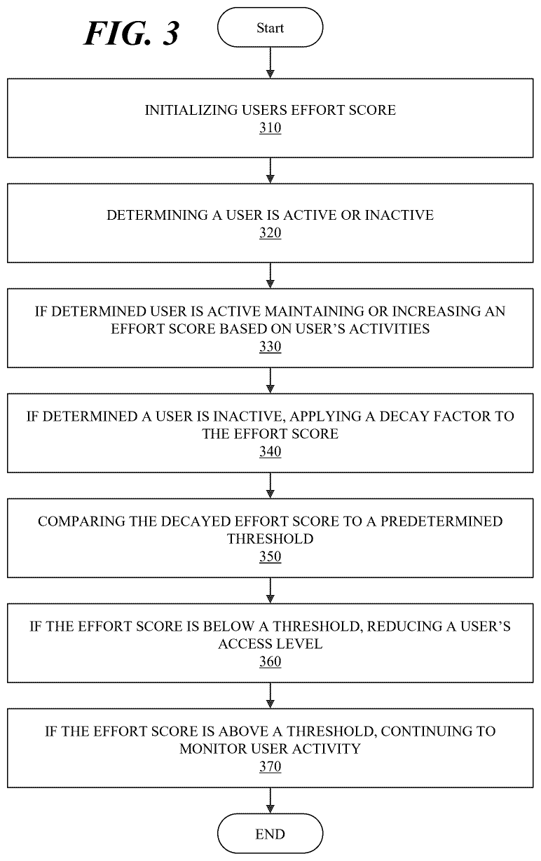

FIG. 3 illustrates an example effort decay model flowchart 300. The model may start with an initial effort score for a user (step 310). If the user remains active (decision 320), the effort score may be maintained or potentially increased based on the user's activities (step 330). If the user becomes inactive (decision 320), a decay factor may be applied to the effort score (step 340). The system may then check if the decayed effort score is below a predefined threshold (decision 350). If the score is below the threshold, the user's access level may be reduced (step 360). If the score is still above the threshold, the system may continue to monitor for user activity (step 370).

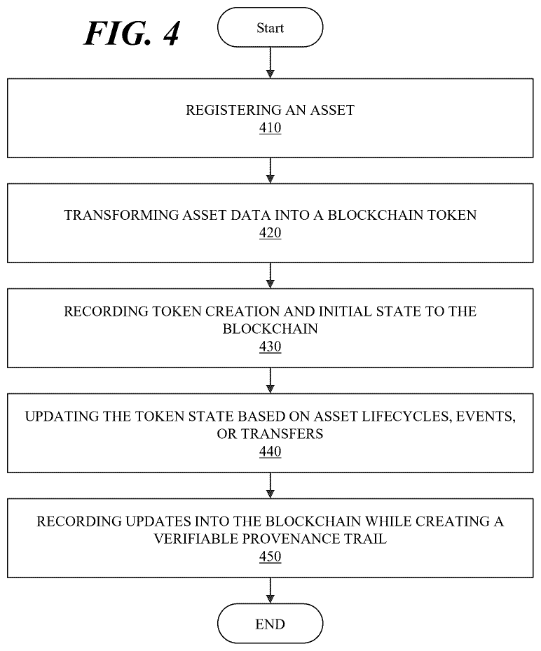

FIG. 4 illustrates an example asset tokenization workflow 400. The process may begin with the registration of an asset (step 410). This may involve capturing asset metadata and ownership information. The asset data may then be transformed into a blockchain token with a unique identifier (step 420). The token creation and initial state may be recorded in the blockchain (step 430). As the asset goes through various lifecycle events or transfers, the token state may be updated (step 440). These updates may be recorded in the blockchain, creating a verifiable provenance trail (step 450).

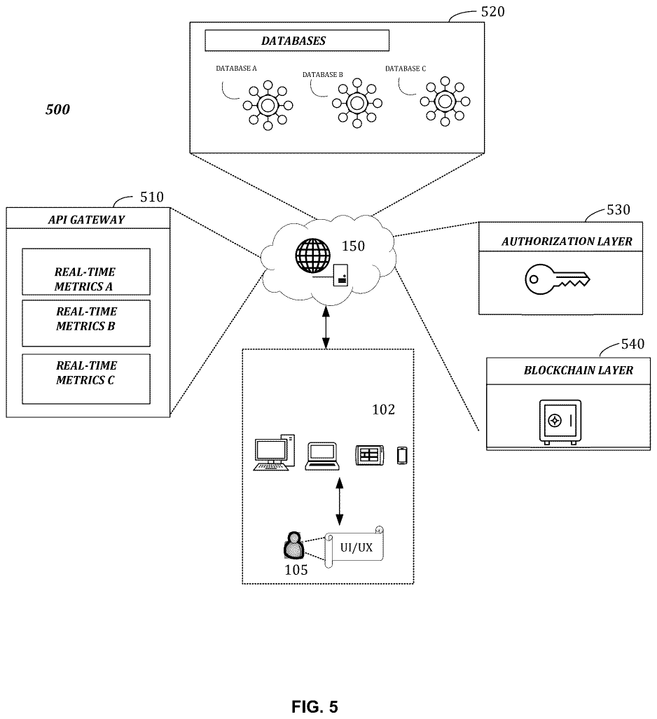

FIG. 5 illustrates an example API integration and data flow diagram 500. Real-time metrics may be collected from various sources through an API Gateway 510. These metrics may be processed and stored in the system's databases 520. The Authorization Layer 530 may use these metrics, along with data from the Blockchain Layer 540, to make access decisions. The system may employ quantum-resistant encryption to protect sensitive data from potential quantum threats. This may involve the use of lattice-based cryptography and zero-knowledge Scalable Transparent ARguments of Knowledge (zk-STARKs).

The system may have cross-industry applicability. In the finance sector, it may be used for adaptive fraud detection based on real-time metrics, transaction validation, and multi-level access for sensitive financial data. In healthcare, it may provide HIPAA-compliant patient data access control based on user roles and behavior metrics. In supply chain management, it may enable immutable asset tracking across logistics stages, verifying the authenticity and origin of goods in transit. In education, it may facilitate secure credentialing and skill verification stored on blockchain, enabling institutions to maintain tamper-proof records. In the public sector, it may support transparent and auditable government record-keeping with secure access controls for authorized personnel.

The system architecture for the proof of effort platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the system architecture for the proof of effort platform 100 may be hosted on a centralized server 150, such as, for example, a cloud computing service. Although method 200, 300, or 400 has been described to be performed by a computing device 600, it should be understood that, in some embodiments, different operations may be performed by different networked elements in operative communication with computing device 600. Embodiments of the present disclosure may comprise a system having a memory storage and a processing unit. The processing unit coupled to the memory storage, wherein the processing unit is configured to perform the stages of method 200, 300, or 400.

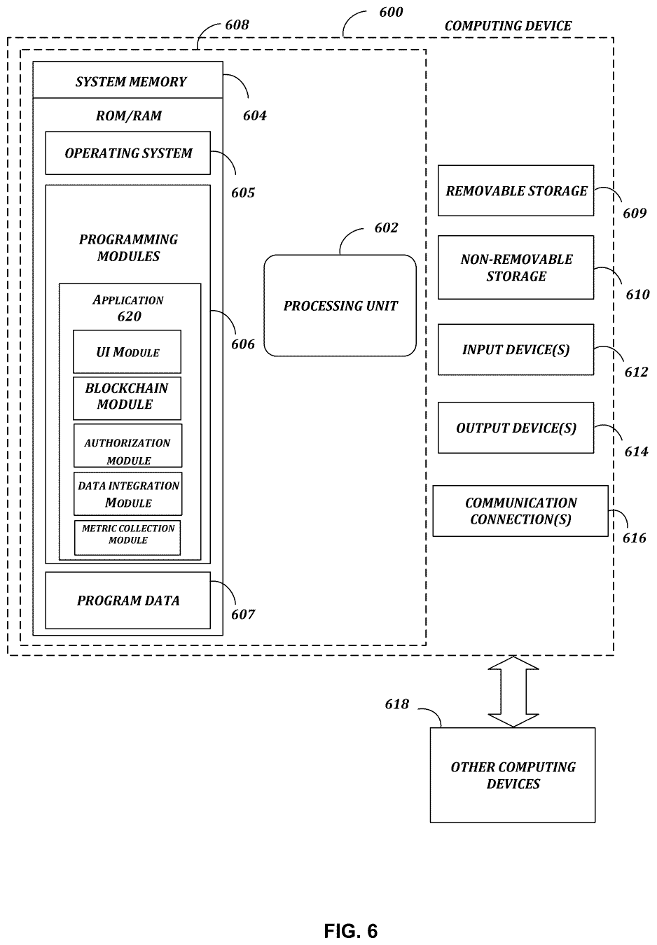

FIG. 6 is a block diagram of a system including computing device 600. Consistent with an embodiment of the disclosure, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the disclosure.

With reference to FIG. 6, a system consistent with an embodiment of the disclosure may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include a user interface module, a blockchain module, an authorization module, a data integration module, a metric collection module, and application 620. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., a user interface module, a blockchain module, an authorization module, a data integration module, and a metric collection module; application 620) may perform processes including, for example, one or more of method 200, 300, or 400's stages as described above. The aforementioned process is an example, and processing unit 602 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

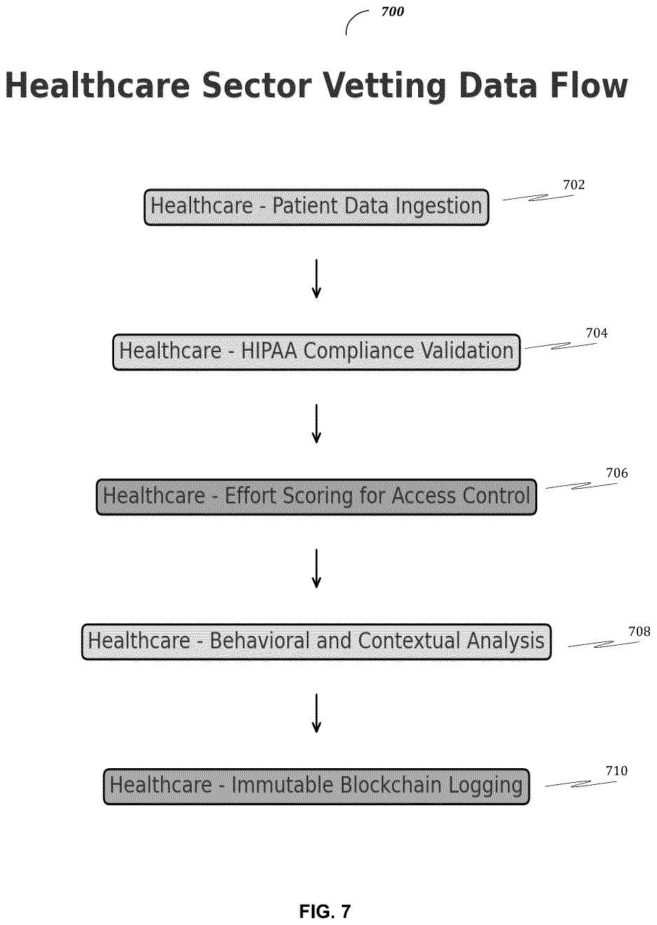

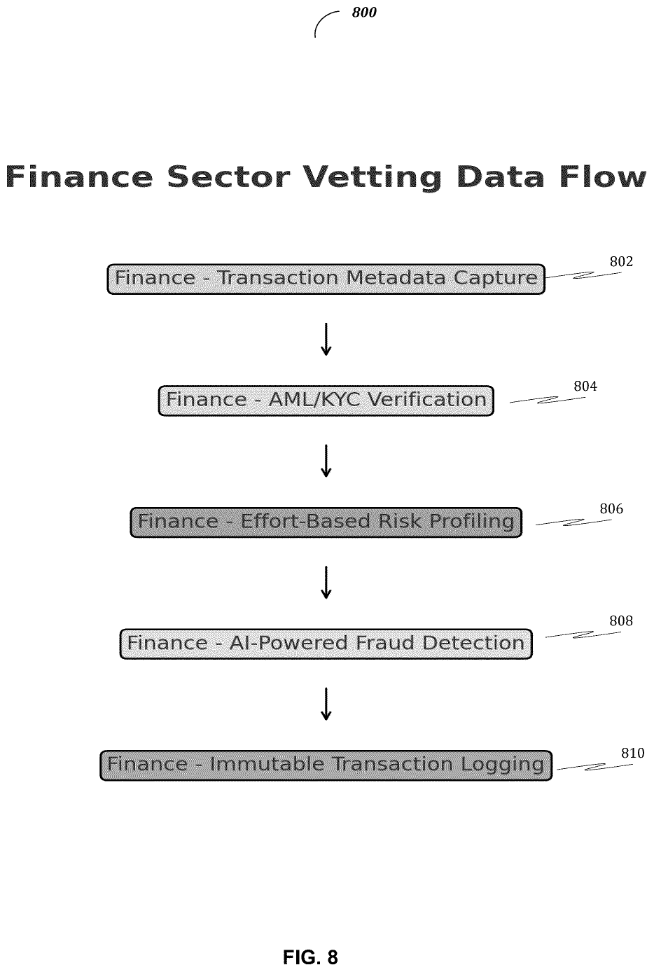

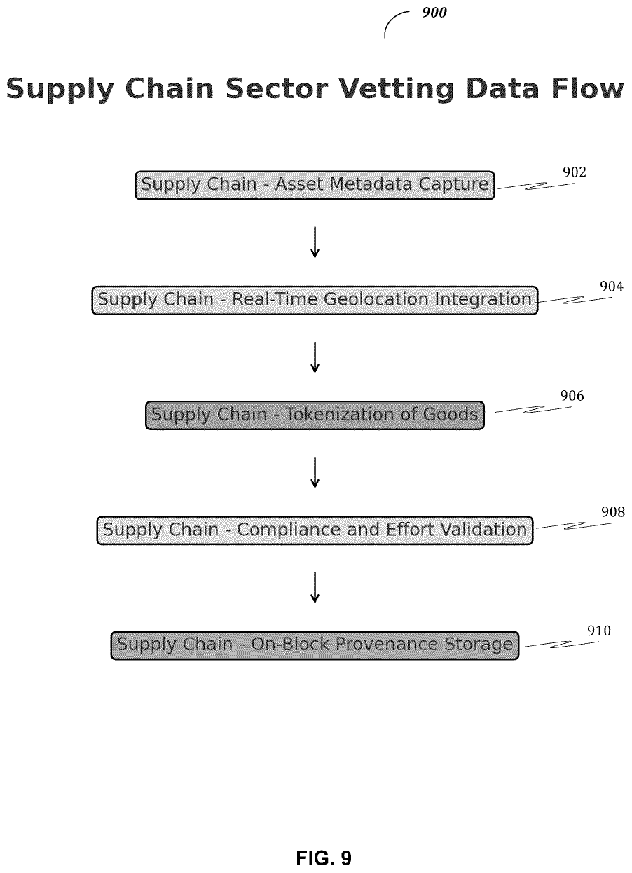

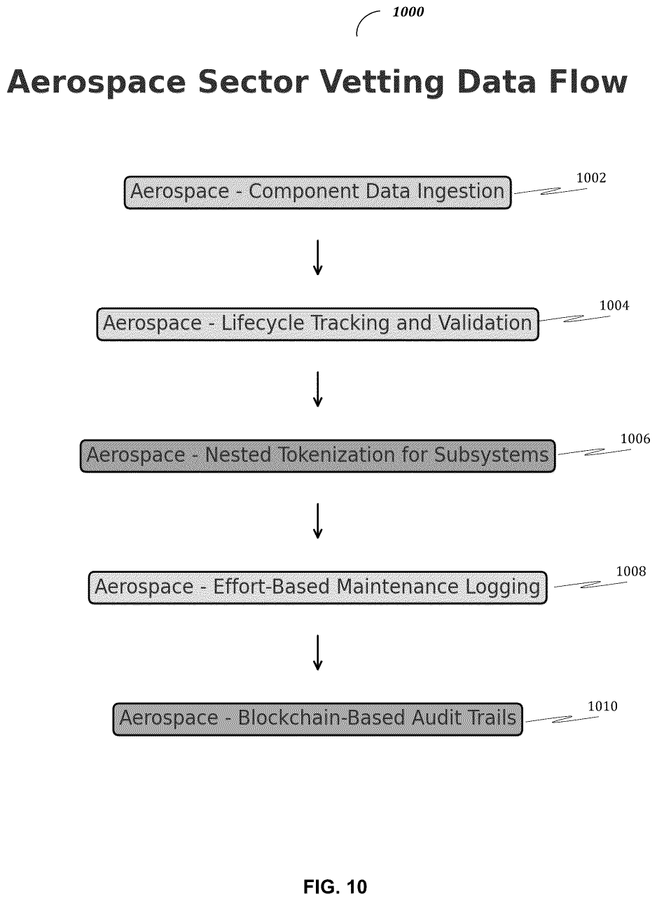

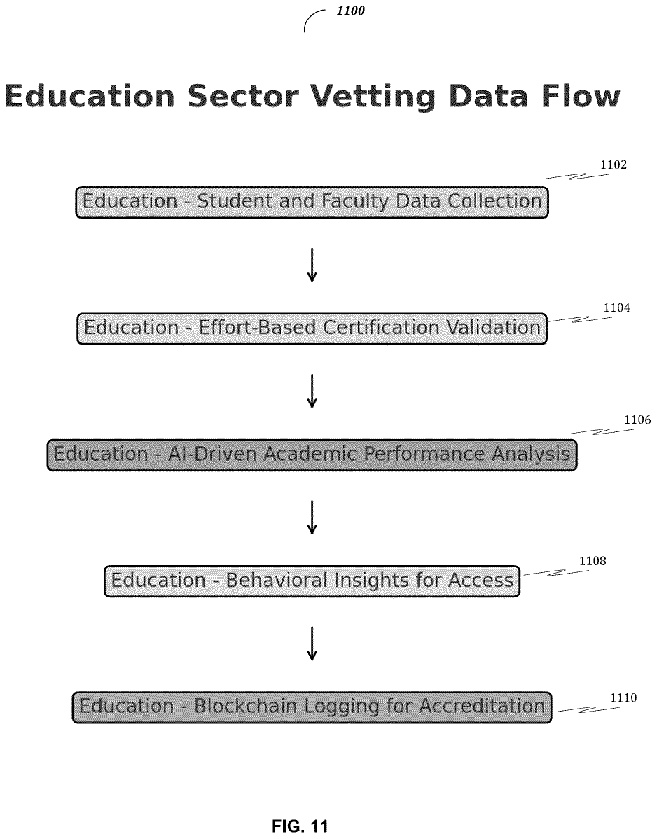

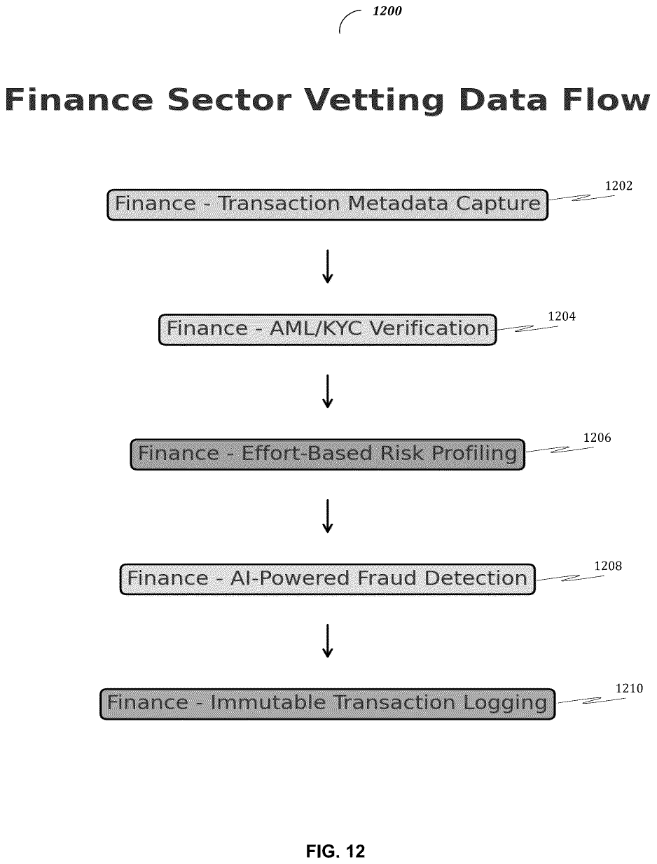

FIGS. 7 through 11 illustrate exemplary embodiments of various use cases for the cross-industry adaptive access control and asset management system with proof-of-effort blockchain architecture across different sectors. These figures demonstrate how the system may be adapted to address specific requirements and workflows in healthcare, finance, supply chain, aerospace, and education industries. For example FIG. 7 may depict a data flow for the healthcare sector. The process may begin with patient data ingestion, followed by HIPAA compliance validation to ensure regulatory adherence. The system may then calculate effort scores for access control, perform behavioral and contextual analysis, and finally log all activities immutably on the blockchain. FIG. 8 may illustrate a data flow for the finance sector. The process may start with transaction metadata capture, proceed to AML/KYC verification, followed by effort-based risk profiling. The system may then employ AI-powered fraud detection and conclude with immutable transaction logging on the blockchain. FIG. 9 may show a data flow for the supply chain sector. The process may begin with asset metadata capture, integrate real-time geolocation data, tokenize goods on the blockchain, perform compliance and effort validation, and finally store provenance information on-block. FIG. 10 may depict a data flow for the aerospace sector. The process may start with component data ingestion, proceed to lifecycle tracking and validation, implement nested tokenization for subsystems, log effort-based maintenance activities, and conclude with blockchain-based audit trails. FIG. 11 may illustrate a data flow for the education sector. The process may begin with student and faculty data collection, validate certifications based on effort, perform AI-driven academic performance analysis, generate behavioral insights for access control, and finally log accreditation-related information on the blockchain. These figures may demonstrate the versatility and adaptability of the cross-industry adaptive access control and asset management system with proof-of-effort blockchain architecture across various industries, showcasing its potential for wide-ranging applications in secure data management, access control, and compliance.

FIG. 7 illustrates a flowchart depicting the data flow process in the healthcare sector vetting. The process comprises five sequential stages, each represented by a colored box connected by arrows indicating the direction of flow. The process begins with the “Healthcare—Patient Data Ingestion” stage, represented by a blue box. This stage may involve the initial collection and input of patient information into the system. Following the data ingestion, the process moves to the “Healthcare—HIPAA Compliance Validation” stage, depicted by a green box. This stage may involve verifying that the collected patient data meets the privacy and security standards set by the Health Insurance Portability and Accountability Act (HIPAA). The third stage, represented by a red box, is “Healthcare—Effort Scoring for Access Control”. This stage may involve calculating an effort score based on various factors to determine the appropriate level of access to patient data. Next, the process moves to the “Healthcare—Behavioral and Contextual Analysis” stage, shown in a yellow box. This stage may involve analyzing user behavior and contextual information to further refine access control decisions. The final stage of the process, depicted by a purple box, is “Healthcare—Immutable Blockchain Logging”. This stage may involve recording all relevant data and access events on a blockchain to ensure an immutable and transparent audit trail. The arrows connecting each stage indicate the sequential flow of the vetting process, from initial data ingestion through compliance validation, effort scoring, behavioral analysis, and finally to blockchain logging. This flowchart provides a visual representation of how patient data may be securely managed and accessed within the healthcare sector using the BlockSiFr system.

FIG. 7 illustrates a flowchart depicting the data flow process in the healthcare sector vetting. The process comprises five sequential stages, each represented by a colored box connected by arrows indicating the direction of flow. The process begins with the Healthcare—Patient Data Ingestion stage (702), represented by a blue box. This stage may involve the initial collection and input of patient information into the system. Following the data ingestion, the process moves to the Healthcare—HIPAA Compliance Validation stage (704), depicted by a green box. This stage may involve verifying that the collected patient data meets the privacy and security standards set by the Health Insurance Portability and Accountability Act (HIPAA). The third stage, represented by a red box, is Healthcare—Effort Scoring for Access Control (706). This stage may involve calculating an effort score based on various factors to determine the appropriate level of access to patient data. Next, the process moves to the Healthcare—Behavioral and Contextual Analysis stage (708), shown in a yellow box. This stage may involve analyzing user behavior and contextual information to further refine access control decisions. The final stage of the process, depicted by a purple box, is Healthcare—Immutable Blockchain Logging (710). This stage may involve recording all relevant data and access events on a blockchain to ensure an immutable and transparent audit trail. The arrows connecting each stage indicate the sequential flow of the vetting process, from initial data ingestion through compliance validation, effort scoring, behavioral analysis, and finally to blockchain logging. This flowchart provides a visual representation of how patient data may be securely managed and accessed within the healthcare sector using the BlockSiFr system.

FIG. 8 illustrates a flowchart depicting the data flow process in the finance sector vetting. The process comprises five sequential stages, each represented by a colored box connected by arrows indicating the direction of flow. The process begins with the “Finance—Transaction Metadata Capture” stage, represented by a blue box. This stage may involve the initial collection and recording of metadata associated with financial transactions. Following the metadata capture, the process moves to the “Finance—AML/KYC Verification” stage, depicted by a green box. This stage may involve verifying the transaction against Anti-Money Laundering (AML) and Know Your Customer (KYC) regulations to ensure compliance. The third stage, represented by a red box, is “Finance—Effort-Based Risk Profiling”. This stage may involve calculating a risk profile based on various effort-related factors associated with the transaction or the parties involved. Next, the process moves to the “Finance—AI-Powered Fraud Detection” stage, shown in a yellow box. This stage may involve using artificial intelligence algorithms to analyze the transaction for potential fraudulent activity. The final stage of the process, depicted by a purple box, is “Finance—Immutable Transaction Logging”. This stage may involve recording all relevant transaction data and verification results on a blockchain to ensure an immutable and transparent audit trail. The arrows connecting each stage indicate the sequential flow of the vetting process, from initial metadata capture through compliance verification, risk profiling, fraud detection, and finally to blockchain logging. This flowchart provides a visual representation of how financial transactions may be securely processed and verified within the finance sector using the BlockSiFr system.

FIG. 8 illustrates a flowchart depicting the data flow process in the finance sector vetting. The process comprises five sequential stages, each represented by a colored box connected by arrows indicating the direction of flow. The process begins with the Finance—Transaction Metadata Capture stage (802), represented by a blue box. This stage involves the initial collection and recording of metadata associated with financial transactions. The metadata may include information such as transaction amount, timestamp, sender and recipient identifiers, transaction type, and any additional contextual data relevant to the financial operation. This comprehensive data capture forms the foundation for subsequent analysis and verification steps.

Following the metadata capture, the process moves to the Finance—AML/KYC Verification stage (804), depicted by a green box. This stage involves verifying the transaction against Anti-Money Laundering (AML) and Know Your Customer (KYC) regulations to ensure compliance. The system may cross-reference the transaction metadata with existing databases of high-risk entities, perform pattern matching to identify suspicious behavior, and validate the identities of the parties involved in the transaction. This step is crucial for maintaining regulatory compliance and preventing financial crimes. The third stage, represented by a red box, is Finance—Effort-Based Risk Profiling (806). This stage involves calculating a risk profile based on various effort-related factors associated with the transaction or the parties involved. The system may consider factors such as the frequency and volume of transactions, the effort expended by users in maintaining their accounts, and the complexity of the financial operations being performed. By incorporating effort-based metrics, the risk profiling becomes more dynamic and reflective of real-world user behavior.

Next, the process moves to the Finance—AI-Powered Fraud Detection stage (808), shown in a yellow box. This stage involves using artificial intelligence algorithms to analyze the transaction for potential fraudulent activity. The AI system may employ machine learning models trained on historical transaction data to identify anomalies, predict fraud likelihood, and flag suspicious transactions for further review. This advanced fraud detection capability enhances the overall security of the financial ecosystem. The final stage of the process, depicted by a purple box, is Finance—Immutable Transaction Logging (810). This stage involves recording all relevant transaction data and verification results on a blockchain to ensure an immutable and transparent audit trail. By leveraging blockchain technology, the system creates a tamper-proof record of all financial activities, including the results of AML/KYC checks, risk profiles, and fraud detection outcomes. This immutable log serves as a reliable source of truth for audits, dispute resolution, and regulatory compliance.

The arrows connecting each stage indicate the sequential flow of the vetting process, from initial metadata capture through compliance verification, risk profiling, fraud detection, and finally to blockchain logging. This flowchart provides a visual representation of how financial transactions may be securely processed and verified within the finance sector using the BlockSiFr system. By implementing this comprehensive vetting process, the BlockSiFr system enhances the security and integrity of financial transactions. The multi-stage approach ensures that each transaction is thoroughly scrutinized from various angles, including regulatory compliance, risk assessment, and fraud prevention. The integration of effort-based metrics and AI-powered analysis adds an additional layer of sophistication to the vetting process, allowing for more nuanced and accurate risk assessments.

The use of blockchain technology for immutable logging provides a robust foundation for auditability and transparency, which are crucial in the financial sector. This feature not only aids in regulatory compliance but also builds trust among participants in the financial ecosystem. The finance sector vetting data flow process illustrated in FIG. 8 demonstrates the BlockSiFr system's capability to address the complex challenges of modern financial transactions, combining advanced technologies with regulatory requirements to create a secure and efficient financial environment.

FIG. 9 illustrates a flowchart depicting the data flow process in the supply chain sector vetting. The process comprises five sequential stages, each represented by a colored box connected by arrows indicating the direction of flow. The process begins with the “Supply Chain—Asset Metadata Capture” stage, represented by a blue box. This stage may involve the initial collection and recording of metadata associated with supply chain assets. Following the metadata capture, the process moves to the “Supply Chain—Real-Time Geolocation Integration” stage, depicted by a green box. This stage may involve incorporating real-time location data of the assets into the system. The third stage, represented by a red box, is “Supply Chain—Tokenization of Goods”. This stage may involve creating digital tokens representing the physical goods in the supply chain, likely using blockchain technology. Next, the process moves to the “Supply Chain—Compliance and Effort Validation” stage, shown in a yellow box. This stage may involve verifying that the supply chain processes comply with relevant regulations and validating the effort involved in each step. The final stage of the process, depicted by a purple box, is “Supply Chain—On-Block Provenance Storage”. This stage may involve recording all relevant supply chain data, including the asset's journey and compliance information, on a blockchain to ensure an immutable and transparent record of provenance. The arrows connecting each stage indicate the sequential flow of the vetting process, from initial metadata capture through geolocation integration, tokenization, compliance validation, and finally to blockchain-based provenance storage. This flowchart provides a visual representation of how supply chain assets may be securely tracked and managed using the BlockSiFr system.

FIG. 9 illustrates a flowchart 900 depicting the data flow process in the supply chain sector vetting. The process comprises five sequential stages, each represented by a colored box connected by arrows indicating the direction of flow. The process begins with the Supply Chain—Asset Metadata Capture stage 902, represented by a blue box. This stage may involve the initial collection and recording of metadata associated with supply chain assets. Following the metadata capture, the process moves to the Supply Chain—Real-Time Geolocation Integration stage 904, depicted by a green box. This stage may involve incorporating real-time location data of the assets into the system. The third stage, represented by a red box, is Supply Chain—Tokenization of Goods 906. This stage may involve creating digital tokens representing the physical goods in the supply chain, likely using blockchain technology. Next, the process moves to the Supply Chain—Compliance and Effort Validation stage 908, shown in a yellow box. This stage may involve verifying that the supply chain processes comply with relevant regulations and validating the effort involved in each step. The final stage of the process, depicted by a purple box, is Supply Chain—On-Block Provenance Storage 910. This stage may involve recording all relevant supply chain data, including the asset's journey and compliance information, on a blockchain to ensure an immutable and transparent record of provenance. The arrows connecting each stage indicate the sequential flow of the vetting process, from initial metadata capture through geolocation integration, tokenization, compliance validation, and finally to blockchain-based provenance storage. This flowchart provides a visual representation of how supply chain assets may be securely tracked and managed using the BlockSiFr system.

FIG. 10 illustrates a flowchart depicting the data flow process in the aerospace sector vetting. The process comprises five sequential stages, each represented by a colored box connected by arrows indicating the direction of flow. The process begins with the “Aerospace—Component Data Ingestion” stage, represented by a blue box. This stage may involve the initial collection and input of data related to aerospace components into the system. Following the data ingestion, the process moves to the “Aerospace—Lifecycle Tracking and Validation” stage, depicted by a green box. This stage may involve monitoring and verifying the lifecycle stages of aerospace components. The third stage, represented by a red box, is “Aerospace—Nested Tokenization for Subsystems”. This stage may involve creating hierarchical digital tokens representing various subsystems within the aerospace components. Next, the process moves to the “Aerospace—Effort-Based Maintenance Logging” stage, shown in a yellow box. This stage may involve recording maintenance activities and the associated effort, possibly using a scoring system. The final stage of the process, depicted by a purple box, is “Aerospace—Blockchain-Based Audit Trails”. This stage may involve recording all relevant component data, lifecycle events, and maintenance logs on a blockchain to ensure an immutable and transparent audit trail. The arrows connecting each stage indicate the sequential flow of the vetting process, from initial data ingestion through lifecycle tracking, nested tokenization, maintenance logging, and finally to blockchain-based audit trails. This flowchart provides a visual representation of how aerospace components may be securely managed and tracked using the BlockSiFr system.

FIG. 10 illustrates a flowchart depicting the data flow process in the aerospace sector vetting. The process comprises five sequential stages, each represented by a colored box connected by arrows indicating the direction of flow. The process begins with the Aerospace—Component Data Ingestion stage (1002), represented by a blue box. This stage may involve the initial collection and input of data related to aerospace components into the system. Following the data ingestion, the process moves to the Aerospace—Lifecycle Tracking and Validation stage (1004), depicted by a green box. This stage may involve monitoring and verifying the lifecycle stages of aerospace components. The third stage, represented by a red box, is Aerospace—Nested Tokenization for Subsystems (1006). This stage may involve creating hierarchical digital tokens representing various subsystems within the aerospace components. Next, the process moves to the Aerospace—Effort-Based Maintenance Logging stage (1008), shown in a yellow box. This stage may involve recording maintenance activities and the associated effort, possibly using a scoring system. The final stage of the process, depicted by a purple box, is Aerospace—Blockchain-Based Audit Trails (1010). This stage may involve recording all relevant component data, lifecycle events, and maintenance logs on a blockchain to ensure an immutable and transparent audit trail. The arrows connecting each stage indicate the sequential flow of the vetting process, from initial data ingestion through lifecycle tracking, nested tokenization, maintenance logging, and finally to blockchain-based audit trails. This flowchart provides a visual representation of how aerospace components may be securely managed and tracked using the BlockSiFr system.

FIG. 11 illustrates a flowchart depicting the data flow process in the education sector vetting. The process comprises five sequential stages, each represented by a colored box connected by arrows indicating the direction of flow. The process begins with the “Education—Student and Faculty Data Collection” stage, represented by a blue box. This stage may involve the initial gathering and input of information related to students and faculty members into the system. Following the data collection, the process moves to the “Education—Effort-Based Certification Validation” stage, depicted by a green box. This stage may involve verifying certifications or qualifications based on effort-related metrics. The third stage, represented by a red box, is “Education—AI-Driven Academic Performance Analysis”. This stage may involve using artificial intelligence algorithms to analyze and evaluate academic performance data. Next, the process moves to the “Education—Behavioral Insights for Access” stage, shown in a yellow box. This stage may involve analyzing behavioral patterns to determine appropriate access levels to educational resources or information. The final stage of the process, depicted by a purple box, is “Education—Blockchain Logging for Accreditation”. This stage may involve recording all relevant educational data, certifications, and access events on a blockchain to ensure an immutable and transparent record for accreditation purposes. The arrows connecting each stage indicate the sequential flow of the vetting process, from initial data collection through certification validation, performance analysis, behavioral insights, and finally to blockchain-based logging for accreditation. This flowchart provides a visual representation of how educational data may be securely managed and utilized within the education sector using the BlockSiFr system. The sequential nature of the flowchart suggests that each step builds upon the previous one, creating a comprehensive vetting process for healthcare data that addresses compliance, security, and auditability concerns.

FIG. 11 illustrates a flowchart depicting the data flow process in the education sector vetting. The process comprises five sequential stages, each represented by a colored box connected by arrows indicating the direction of flow. The process begins with the Education—Student and Faculty Data Collection stage (1102), represented by a blue box. This stage may involve the initial gathering and input of information related to students and faculty members into the system. Following the data collection, the process moves to the Education—Effort-Based Certification Validation stage (1104), depicted by a green box. This stage may involve verifying certifications or qualifications based on effort-related metrics. The third stage, represented by a red box, is Education—AI-Driven Academic Performance Analysis (1106). This stage may involve using artificial intelligence algorithms to analyze and evaluate academic performance data. Next, the process moves to the Education—Behavioral Insights for Access stage (1108), shown in a yellow box. This stage may involve analyzing behavioral patterns to determine appropriate access levels to educational resources or information. The final stage of the process, depicted by a purple box, is Education—Blockchain Logging for Accreditation (1110). This stage may involve recording all relevant educational data, certifications, and access events on a blockchain to ensure an immutable and transparent record for accreditation purposes. The arrows connecting each stage indicate the sequential flow of the vetting process, from initial data collection through certification validation, performance analysis, behavioral insights, and finally to blockchain-based logging for accreditation. This flowchart provides a visual representation of how educational data may be securely managed and utilized within the education sector using the BlockSiFr system. The sequential nature of the flowchart suggests that each step may build upon the previous one, creating a comprehensive vetting process for educational data that may address compliance, security, and auditability concerns.

The metric collection layer may be configured to capture a wide range of user metrics from integrated systems. These metrics may include, but may not be limited to, task completion rates, accuracy of completed tasks, engagement levels, login frequency, duration of active sessions, and interaction patterns with various system components. The metric collection layer may utilize APIs and data connectors to interface with external systems such as Azure Active Directory, Cisco Identity Services Engine, and other third-party applications to gather real-time user behavior data.

In some embodiments, the metric collection layer may employ machine learning algorithms to analyze and categorize user actions, assigning weighted values to different types of activities based on their relevance to the user's role and responsibilities. This adaptive scoring mechanism may allow for a more nuanced and context-aware evaluation of user effort within the system. The blockchain layer may provide an immutable, quantum-resistant ledger for storing access events, asset records, and compliance data. This layer may utilize advanced cryptographic techniques, such as lattice-based cryptography or multivariate cryptography, to ensure the long-term security of stored data against potential quantum computing threats. The blockchain layer may implement a hybrid model that combines on-block and off-block storage to optimize performance and scalability.

In certain implementations, the blockchain layer may employ a consensus mechanism specifically designed for the PoE ecosystem, which may take into account user effort scores and system-wide trust metrics when validating and adding new blocks to the chain. This custom consensus algorithm may enhance the overall security and efficiency of the blockchain network while aligning with the effort-based principles of the system.

The authorization layer, which may include the BlockCipher Module, may be responsible for managing adaptive access control based on effort scores, access thresholds, and effort decay mechanisms. This layer may continuously evaluate user effort scores against predefined thresholds and apply decay factors to ensure that access privileges remain commensurate with ongoing user engagement and contributions.

The BlockCipher Module may implement a multi-factor decision-making process that considers not only the current effort score but also historical patterns, contextual information, and risk assessments when granting or restricting access to resources. This adaptive approach may allow for more granular and dynamic access control, enhancing security while maintaining user productivity.

The data integration layer may serve as the interface between the PoE Blockchain Ecosystem and external applications, facilitating seamless data access, analytics, and reporting. This layer may provide a set of standardized APIs and data exchange protocols to enable interoperability with a wide range of enterprise systems and third-party tools.

In some embodiments, the data integration layer may incorporate advanced data transformation and normalization techniques to ensure consistency and compatibility across different data sources and formats. This may include the ability to handle structured, semi-structured, and unstructured data, allowing for comprehensive analysis and insights generation.

The system may implement a robust encryption scheme to protect data both at rest and in transit. This may include the use of quantum-resistant encryption algorithms for sensitive data stored on the blockchain, as well as secure communication protocols for data exchange between system components and external applications.

To enhance the system's resilience against potential attacks, a multi-layered security architecture may be employed. This may include network segmentation, intrusion detection and prevention systems, and regular security audits and penetration testing to identify and address vulnerabilities proactively.

The PoE Blockchain Ecosystem may incorporate a sophisticated anomaly detection mechanism that leverages machine learning algorithms to identify unusual patterns or behaviors within the system. This may help in early detection of potential security threats, unauthorized access attempts, or fraudulent activities.

In certain implementations, the system may provide a comprehensive audit trail of all access events, asset transactions, and system configuration changes. This audit trail may be stored on the blockchain to ensure immutability and non-repudiation, facilitating compliance with various regulatory requirements and industry standards.

The system may offer a flexible and extensible architecture that allows for the integration of additional modules and functionalities to meet specific industry or organizational requirements. This modular approach may enable customization and scalability of the PoE Blockchain Ecosystem across different use cases and sectors.

### ASPECTS OF THE INVENTION

The following disclose various Aspects of the present disclosure. The various Aspects are not to be construed as patent claims unless the language of the Aspect appears as a patent claim. The Aspects describe various non-limiting embodiments of the present disclosure.
Aspect 1. A system for adaptive access control, comprising: a metric collection layer configured to capture real-time user metrics from integrated systems; a blockchain layer configured to provide an immutable ledger for storing access events; an authorization layer configured to manage access control based on effort scores and thresholds; and wherein the authorization layer is further configured to implement effort decay mechanisms to dynamically adjust user access levels over time.
Aspect 2. The system of aspect 1, wherein the metric collection layer comprises: an artificial intelligence engine configured to perform sentiment analysis on user interactions; a device posture assessment module configured to analyze device security status; and an Internet of Things (IoT) telemetry integration module configured to collect data from IoT devices.
Aspect 3. The system of aspect 1, wherein the blockchain layer is configured to: implement dynamic Scalable Transparent ARguments of Knowledge (STARK) proofs for cryptographic validation; utilize a segmented block schema optimized for querying efficiency; and employ sharded processing to enable parallel transaction handling.
Aspect 4. The system of aspect 1, wherein the authorization layer comprises: a context-aware access control module configured to adjust permissions based on environmental and behavioral inputs; a behavioral baseline modeling module configured to identify anomalies; and a predictive privilege adjustment module configured to preemptively modify access levels.
Aspect 5. A method for effort-based access control, comprising: collecting real-time user metrics from integrated systems; calculating a current effort score based on the collected metrics; retrieving access thresholds and decay factors from a blockchain; comparing the effort score to the thresholds and applying the decay factors; making an access decision based on the comparison; and logging the access event and decision in the blockchain.
Aspect 6. The method of aspect 5, further comprising: continuously monitoring user behavior and updating the effort score; and triggering adaptive multi-factor authentication if the effort score falls below a threshold.
Aspect 7. The method of aspect 5, wherein collecting real-time user metrics comprises: performing sentiment analysis on user communications; assessing device security posture; and integrating telemetry data from IoT devices.
Aspect 8. The method of aspect 5, wherein calculating the current effort score comprises: applying machine learning algorithms to analyze user behavior patterns; factoring in contextual data including time, location, and device information; and weighting different types of user activities based on predetermined criteria.
Aspect 9. A system for asset tokenization and management, comprising: a blockchain layer configured to provide an immutable ledger; an asset tokenization module configured to transform asset data into blockchain tokens; and a provenance tracking module configured to record asset lifecycle events and transfers; wherein the blockchain layer implements quantum-resistant cryptography.
Aspect 10. The system of aspect 9, further comprising: a real-time geolocation module configured to add spatial metadata to asset tokens; and a zero-knowledge proof module configured to enable confidential verification of asset provenance.
Aspect 11. A method for asset tokenization and management, comprising: registering an asset by capturing asset metadata and ownership information; transforming the asset data into a blockchain token with a unique identifier; recording the token creation and initial state in a blockchain; updating the token state with each lifecycle event or transfer of the asset; and creating a verifiable provenance trail by recording the updates in the blockchain.
Aspect 12. The method of aspect 11, further comprising: integrating real-time geolocation data with the asset token; and implementing zero-knowledge proofs for privacy-preserving verification of asset states.
Aspect 13. A system for cross-industry adaptive access control and asset management, comprising: a processor; a memory coupled to the processor, the memory storing instructions that, when executed by the processor, cause the system to: collect real-time user metrics from integrated systems; calculate effort scores based on the collected metrics; manage adaptive access control based on the effort scores, access thresholds, and effort decay mechanisms; tokenize assets on a blockchain; and provide quantum-resistant data protection for stored data.
Aspect 14. The system of aspect 13, wherein the instructions further cause the system to: implement a BlockSiFr Session Protocol for secure communication sessions; and utilize AI-driven anomaly detection for real-time threat identification.
Aspect 15. A method for managing access privileges dynamically based on effort decay, comprising: establishing effort-based thresholds for maintaining user privileges; dynamically reducing effort scores over a predefined decay period when additional contributions are not validated; adjusting or revoking privileges automatically when effort scores fall below minimum thresholds; generating proactive notifications for users nearing effort expiration; and logging all privilege changes and effort decay events immutably on a blockchain.
Aspect 16. An administrative dashboard for managing effort-based workflows and access control, comprising: a conversational AI module for querying real-time data; interactive visualization tools for displaying dynamic graphs linked to blockchain-validated data; a recommendation engine that uses AI to propose remediation actions for flagged issues; and exportable audit logs that comply with regulatory standards.
Aspect 17. A multi-layered data validation system, comprising: an AI engine to preprocess and validate data inputs from multiple sources; a blockchain infrastructure to immutably store validated data; and an audit module that provides traceability and verification of all data entries.
Aspect 18. A token system for incentivizing validated effort, comprising: an AI-based validation module that ensures tokens are issued for genuine contributions; a blockchain ledger to record the issuance, redemption, and transfer of tokens; a mechanism for linking tokens to real-world assets to provide intrinsic value; and a decay engine that adjusts token value over time based on user activity or inactivity.
Aspect 19. A method for secure session management, comprising: initiating a session using a quantum-resistant handshake protocol; dynamically authenticating the session based on continuous user activity monitoring; adjusting session privileges in real-time based on effort scores and risk assessments; and immutably logging session metadata on a blockchain for audit purposes.
Aspect 20. A system for supply chain management, comprising: IoT devices and RFID sensors configured to capture product movement and environmental data; an AI-powered provenance analysis engine that uses graph neural networks to verify product origins; a blockchain ledger configured to immutably record supply chain events; and smart contracts configured to automate workflows based on blockchain-validated data.
Aspect 21. A system for adaptive access control, comprising: a metric collection layer configured to capture real-time user metrics from integrated systems; a blockchain layer configured to provide an immutable ledger for storing access events; an authorization layer configured to manage access control based on effort scores and thresholds; and wherein the authorization layer is further configured to implement effort decay mechanisms to dynamically adjust user access levels over time.
Aspect 22. The system of aspect 21, wherein the metric collection layer comprises: an artificial intelligence engine configured to perform sentiment analysis on user interactions; a device posture assessment module configured to analyze device security status; and an Internet of Things (IoT) telemetry integration module configured to collect data from IoT devices.
Aspect 23. The system of aspect 21, wherein the blockchain layer is configured to: implement dynamic Scalable Transparent ARguments of Knowledge (STARK) proofs for cryptographic validation; utilize a segmented block schema optimized for querying efficiency; and employ sharded processing to enable parallel transaction handling.
Aspect 24. The system of aspect 21, wherein the authorization layer comprises: a context-aware access control module configured to adjust permissions based on environmental and behavioral inputs; a behavioral baseline modeling module configured to identify anomalies; and a predictive privilege adjustment module configured to preemptively modify access levels.
Aspect 25. A method for effort-based access control, comprising: collecting real-time user metrics from integrated systems; calculating a current effort score based on the collected metrics; retrieving access thresholds and decay factors from a blockchain; comparing the effort score to the thresholds and applying the decay factors; making an access decision based on the comparison; and logging the access event and decision in the blockchain.
Aspect 26. The method of aspect 25, further comprising: continuously monitoring user behavior and updating the effort score; and triggering adaptive multi-factor authentication if the effort score falls below a threshold.
Aspect 27. The method of aspect 25, wherein collecting real-time user metrics comprises: performing sentiment analysis on user communications; assessing device security posture; and integrating telemetry data from IoT devices.
Aspect 28. The method of aspect 25, wherein calculating the current effort score comprises: applying machine learning algorithms to analyze user behavior patterns; factoring in contextual data including time, location, and device information; and weighing different types of user activities based on predetermined criteria.
Aspect 29. A system for asset tokenization and management, comprising: a blockchain layer configured to provide an immutable ledger; an asset tokenization module configured to transform asset data into blockchain tokens; and a provenance tracking module configured to record asset lifecycle events and transfers; wherein the blockchain layer implements quantum-resistant cryptography.
Aspect 30. The system of aspect 29, further comprising: a real-time geolocation module configured to add spatial metadata to asset tokens; and a zero-knowledge proof module configured to enable confidential verification of asset provenance.
Aspect 31. A method for asset tokenization and management, comprising: registering an asset by capturing asset metadata and ownership information; transforming the asset data into a blockchain token with a unique identifier; recording the token creation and initial state in a blockchain; updating the token state with each lifecycle event or transfer of the asset; and creating a verifiable provenance trail by recording the updates in the blockchain.
Aspect 32. The method of aspect 31, further comprising: integrating real-time geolocation data with the asset token; and implementing zero-knowledge proofs for privacy-preserving verification of asset states.
Aspect 33. A system for cross-industry adaptive access control and asset management, comprising: a processor; a memory coupled to the processor, the memory storing instructions that, when executed by the processor, cause the system to: collect real-time user metrics from integrated systems; calculate effort scores based on the collected metrics; manage adaptive access control based on the effort scores, access thresholds, and effort decay mechanisms; tokenize assets on a blockchain; and provide quantum-resistant data protection for stored data.
Aspect 34. The system of aspect 33, wherein the instructions further cause the system to: implement a BlockSiFr Session Protocol for secure communication sessions; and utilize AI-driven anomaly detection for real-time threat identification.
Aspect 35. A method for managing access privileges dynamically based on effort decay, comprising: establishing effort-based thresholds for maintaining user privileges; dynamically reducing effort scores over a predefined decay period when additional contributions are not validated; adjusting or revoking privileges automatically when effort scores fall below minimum thresholds; generating proactive notifications for users nearing effort expiration; and logging all privilege changes and effort decay events immutably on a blockchain.
Aspect 36. An administrative dashboard for managing effort-based workflows and access control, comprising: a conversational AI module for querying real-time data; interactive visualization tools for displaying dynamic graphs linked to blockchain-validated data; a recommendation engine that uses AI to propose remediation actions for flagged issues; and exportable audit logs that comply with regulatory standards.
Aspect 37. A multi-layered data validation system, comprising: an AI engine to preprocess and validate data inputs from multiple sources; a blockchain infrastructure to immutably store validated data; and an audit module that provides traceability and verification of all data entries.
Aspect 38. A token system for incentivizing validated effort, comprising: an AI-based validation module that ensures tokens are issued for genuine contributions; a blockchain ledger to record the issuance, redemption, and transfer of tokens; a mechanism for linking tokens to real-world assets to provide intrinsic value; and a decay engine that adjusts token value over time based on user activity or inactivity.
Aspect 39. A method for secure session management, comprising: initiating a session using a quantum-resistant handshake protocol; dynamically authenticating the session based on continuous user activity monitoring; adjusting session privileges in real-time based on effort scores and risk assessments; and immutably logging session metadata on a blockchain for audit purposes.
Aspect 40. A system for supply chain management, comprising: IoT devices and RFID sensors configured to capture product movement and environmental data; an AI-powered provenance analysis engine that uses graph neural networks to verify product origins; a blockchain ledger configured to immutably record supply chain events; and smart contracts configured to automate workflows based on blockchain-validated data. In some aspects, the techniques described herein relate to a system for adaptive access control, including: a metric collection layer configured to capture real-time user metrics from integrated systems; a blockchain layer configured to provide an immutable ledger for storing access events; an authorization layer configured to manage access control based on effort scores and thresholds; and wherein the authorization layer is further configured to implement effort decay mechanisms to dynamically adjust user access levels over time.

In some aspects, the techniques described herein relate to a system, wherein the metric collection layer includes: an artificial intelligence engine configured to perform sentiment analysis on user interactions; a device posture assessment module configured to analyze device security status; and an Internet of Things (IoT) telemetry integration module configured to collect data from IoT devices.

In some aspects, the techniques described herein relate to a system, wherein the blockchain layer is configured to: implement dynamic Scalable Transparent ARguments of Knowledge (STARK) proofs for cryptographic validation; utilize a segmented block schema optimized for querying efficiency; and employ sharded processing to enable parallel transaction handling.

In some aspects, the techniques described herein relate to a system, wherein the authorization layer includes: a context-aware access control module configured to adjust permissions based on environmental and behavioral inputs; a behavioral baseline modeling module configured to identify anomalies; and a predictive privilege adjustment module configured to preemptively modify access levels.

In some aspects, the techniques described herein relate to a method for effort-based access control, including: collecting real-time user metrics from integrated systems; calculating a current effort score based on the collected metrics; retrieving access thresholds and decay factors from a blockchain; comparing the effort score to the thresholds and applying the decay factors; making an access decision based on the comparison; and logging the access event and decision in the blockchain.

In some aspects, the techniques described herein relate to a method, further including: continuously monitoring user behavior and updating the effort score; and triggering adaptive multi-factor authentication if the effort score falls below a threshold.

In some aspects, the techniques described herein relate to a method, wherein collecting real-time user metrics includes: performing sentiment analysis on user communications; assessing device security posture; and integrating telemetry data from IoT devices.

In some aspects, the techniques described herein relate to a method, wherein calculating the current effort score includes: applying machine learning algorithms to analyze user behavior patterns; factoring in contextual data including time, location, and device information; and weighing different types of user activities based on predetermined criteria.

In some aspects, the techniques described herein relate to a system for asset tokenization and management, including: a blockchain layer configured to provide an immutable ledger; an asset tokenization module configured to transform asset data into blockchain tokens; and a provenance tracking module configured to record asset lifecycle events and transfers; wherein the blockchain layer implements quantum-resistant cryptography.

In some aspects, the techniques described herein relate to a system, further including: a real-time geolocation module configured to add spatial metadata to asset tokens; and a zero-knowledge proof module configured to enable confidential verification of asset provenance.

In some aspects, the techniques described herein relate to a method for asset tokenization and management, including: registering an asset by capturing asset metadata and ownership information; transforming the asset data into a blockchain token with a unique identifier; recording the token creation and initial state in a blockchain; updating the token state with each lifecycle event or transfer of the asset; and creating a verifiable provenance trail by recording the updates in the blockchain.

In some aspects, the techniques described herein relate to a method, further including: integrating real-time geolocation data with the asset token; and implementing zero-knowledge proofs for privacy-preserving verification of asset states.

In some aspects, the techniques described herein relate to a system for cross-industry adaptive access control and asset management, including: a processor; a memory coupled to the processor, the memory storing instructions that, when executed by the processor, cause the system to: collect real-time user metrics from integrated systems; calculate effort scores based on the collected metrics; manage adaptive access control based on the effort scores, access thresholds, and effort decay mechanisms; tokenize assets on a blockchain; and provide quantum-resistant data protection for stored data.

In some aspects, the techniques described herein relate to a system, wherein the instructions further cause the system to: implement a BlockSiFr Session Protocol for secure communication sessions; and utilize AI-driven anomaly detection for real-time threat identification.

In some aspects, the techniques described herein relate to a method for managing access privileges dynamically based on effort decay, including: establishing effort-based thresholds for maintaining user privileges; dynamically reducing effort scores over a predefined decay period when additional contributions are not validated; adjusting or revoking privileges automatically when effort scores fall below minimum thresholds; generating proactive notifications for users nearing effort expiration; and logging all privilege changes and effort decay events immutably on a blockchain.

In some aspects, the techniques described herein relate to an administrative dashboard for managing effort-based workflows and access control, including: a conversational AI module for querying real-time data; interactive visualization tools for displaying dynamic graphs linked to blockchain-validated data; a recommendation engine that uses AI to propose remediation actions for flagged issues; and exportable audit logs that comply with regulatory standards.

In some aspects, the techniques described herein relate to a multi-layered data validation system, including: an AI engine to preprocess and validate data inputs from multiple sources; a blockchain infrastructure to immutably store validated data; and an audit module that provides traceability and verification of all data entries.

In some aspects, the techniques described herein relate to a token system for incentivizing validated effort, including: an AI-based validation module that ensures tokens are issued for genuine contributions; a blockchain ledger to record the issuance, redemption, and transfer of tokens; a mechanism for linking tokens to real-world assets to provide intrinsic value; and a decay engine that adjusts token value over time based on user activity or inactivity.

In some aspects, the techniques described herein relate to a method for secure session management, including: initiating a session using a quantum-resistant handshake protocol; dynamically authenticating the session based on continuous user activity monitoring; adjusting session privileges in real-time based on effort scores and risk assessments; and immutably logging session metadata on a blockchain for audit purposes.

In some aspects, the techniques described herein relate to a system for supply chain management, including: IoT devices and RFID sensors configured to capture product movement and environmental data; an AI-powered provenance analysis engine that uses graph neural networks to verify product origins; a blockchain ledger configured to immutably record supply chain events; and smart contracts configured to automate workflows based on blockchain-validated data.

Furthermore, these Aspects describe various non-limiting embodiments of the present disclosure. The PoE Blockchain Ecosystem may comprise a system for adaptive access control and asset management. This system may include a metric collection layer configured to capture real-time user metrics from integrated systems. The system may also include a blockchain layer configured to provide an immutable, quantum-resistant ledger for storing access events, asset records, and compliance data. An authorization layer may be configured to manage adaptive access control based on effort scores, access thresholds, and effort decay mechanisms. Additionally, a data integration layer may be configured to interface with external applications for data access, analytics, and reporting.

The metric collection layer may be further configured to capture task completion, accuracy, and engagement metrics. This allows for a comprehensive assessment of user effort and activity. The blockchain layer may employ a hybrid blockchain model combining on-block and off-block storage. This approach may optimize data storage and retrieval while maintaining security and immutability.

The authorization layer may include a BlockCipher Module configured to make access decisions based on calculated effort scores and predefined thresholds. This module enables dynamic and context-aware access control. The data integration layer may be further configured to facilitate integration of AI algorithms for behavior analysis and predictive insights. This integration enhances the system's ability to adapt to changing user patterns and potential security threats.

A method for adaptive access control may be implemented within the system. This method may involve receiving a user authentication request and collecting real-time user metrics from integrated systems. A current effort score may be calculated based on the collected metrics. Access thresholds and decay factors may be retrieved from the blockchain. The effort score may be compared to the thresholds and the decay factors applied. An access decision may be made based on this comparison. The access event and decision may be logged in the blockchain. User behavior may be continuously monitored and the effort score updated accordingly.

The method may further comprise triggering adaptive multi-factor authentication if the effort score falls below a threshold. This adds an extra layer of security for potentially risky access attempts. The real-time user metrics collected may include task completion, accuracy, and engagement metrics. These metrics provide a comprehensive view of user activity and effort. The blockchain employed in the system may utilize quantum-resistant cryptography. This ensures the long-term security of the stored data against potential quantum computing threats. The method may also involve applying AI algorithms for anomaly detection in user behavior. This enhances the system's ability to identify and respond to unusual or potentially malicious activities.

A method for asset tokenization and management may also be implemented within the system. This method may involve registering an asset by capturing asset metadata and ownership information. The asset data may be transformed into a blockchain token with a unique identifier. The token creation and initial state may be recorded in the blockchain. The token state may be updated with each lifecycle event or transfer of the asset. A verifiable provenance trail may be created by recording these updates in the blockchain. The blockchain used for asset tokenization may employ quantum-resistant cryptography, ensuring long-term security of asset records. The method may further comprise applying zero-knowledge Scalable Transparent ARguments of Knowledge (zk-STARKs) for privacy-preserving verification of asset states. This allows for secure verification without revealing sensitive information.

The asset being tokenized and managed may be a digital or physical asset. This flexibility allows the system to handle a wide range of asset types across various industries. The method may also involve integrating with external systems for real-time asset tracking and verification. This integration enhances the system's ability to provide up-to-date and accurate asset information.

The PoE Blockchain Ecosystem may be implemented as a cross-industry adaptive access control and asset management system. This system may comprise a processor and a memory coupled to the processor. The memory may store instructions that, when executed by the processor, cause the system to perform various functions. These functions may include collecting real-time user metrics from integrated systems and calculating effort scores based on the collected metrics. The system may manage adaptive access control based on the effort scores, access thresholds, and effort decay mechanisms. Assets may be tokenized on a blockchain, and quantum-resistant data protection may be provided for stored data.

The system may be further configured to integrate AI for behavior analysis and anomaly detection. This enhances the system's ability to identify and respond to unusual patterns or potential security threats. The system may be designed for use in multiple industries including finance, healthcare, supply chain, education, and public sector. This versatility allows for wide-ranging applications across various domains.

The blockchain employed in the system may use a hybrid model combining on-block and off-block storage. This approach optimizes data management while maintaining security and immutability. The system may also be configured to trigger adaptive multi-factor authentication based on the effort scores. This adds an extra layer of security when user effort falls below certain thresholds.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure. All rights including copyrights in the code included herein are vested in and the property of the Applicant. The Applicant retains and reserves all rights in the code included herein, and grants permission to reproduce the material only in connection with reproduction of the granted patent and for no other purpose.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for adaptive access control, comprising:
a metric collection layer configured to capture real-time user metrics from integrated systems;
a blockchain layer configured to provide an immutable ledger for storing access events;
an authorization layer configured to manage access control based on effort scores and thresholds; and
wherein the authorization layer is further configured to implement effort decay mechanisms to dynamically adjust user access levels over time.

2. The system of claim 1, wherein the metric collection layer comprises:
an artificial intelligence engine configured to perform sentiment analysis on user interactions;
a device posture assessment module configured to analyze device security status; and
an Internet of Things (IoT) telemetry integration module configured to collect data from IoT devices.

3. The system of claim 1, wherein the blockchain layer is configured to:
implement dynamic Scalable Transparent ARguments of Knowledge (STARK) proofs for cryptographic validation;
utilize a segmented block schema optimized for querying efficiency; and
employ sharded processing to enable parallel transaction handling.

4. The system of claim 1, wherein the authorization layer comprises:
a context-aware access control module configured to adjust permissions based on environmental and behavioral inputs;
a behavioral baseline modeling module configured to identify anomalies; and
a predictive privilege adjustment module configured to preemptively modify access levels.

5. A method for effort-based access control, comprising:
collecting real-time user metrics from integrated systems;
calculating a current effort score based on the collected metrics;
retrieving access thresholds and decay factors from a blockchain;
comparing the effort score to the thresholds and applying the decay factors;
making an access decision based on the comparison; and
logging the access event and decision in the blockchain.

6. The method of claim 5, further comprising:
continuously monitoring user behavior and updating the effort score; and
triggering adaptive multi-factor authentication if the effort score falls below a threshold.

7. The method of claim 5, wherein collecting real-time user metrics comprises:
performing sentiment analysis on user communications;
assessing device security posture; and
integrating telemetry data from IoT devices.

8. The method of claim 5, wherein calculating the current effort score comprises:
applying machine learning algorithms to analyze user behavior patterns;
factoring in contextual data including time, location, and device information; and
weighing different types of user activities based on predetermined criteria.

9. A system for asset tokenization and management, comprising:
a blockchain layer configured to provide an immutable ledger;
an asset tokenization module configured to transform asset data into blockchain tokens;
a provenance tracking module configured to record asset lifecycle events and transfers; and
wherein the blockchain layer implements quantum-resistant cryptography.

10. The system of claim 9, further comprising:
a real-time geolocation module configured to add spatial metadata to asset tokens; and
a zero-knowledge proof module configured to enable confidential verification of asset provenance.

11. The system of claim 9, wherein the asset tokenization module is further configured to:
register an asset by capturing asset metadata and ownership information;
transform the asset data into a blockchain token with a unique identifier;
record the token creation and initial state in the blockchain; and
update the token state with each lifecycle event or transfer of the asset.

12. The system of claim 9, further comprising:
a processor; and
a memory coupled to the processor, the memory storing instructions that, when executed by the processor, cause the system to:
collect real-time user metrics from integrated systems;
calculate effort scores based on the collected metrics; and
manage adaptive access control based on the effort scores, access thresholds, and effort decay mechanisms.

13. The system of claim 12, wherein the instructions further cause the system to:
implement a BlockSiFr Session Protocol for secure communication sessions; and
utilize AI-driven anomaly detection for real-time threat identification.

14. The system of claim 12, wherein the instructions further cause the system to:
establish effort-based thresholds for maintaining user privileges;
dynamically reduce effort scores over a predefined decay period when additional contributions are not validated;
adjust or revoke privileges automatically when effort scores fall below minimum thresholds; and
generate proactive notifications for users nearing effort expiration.

15. The system of claim 9, further comprising an administrative dashboard including:
a conversational AI module for querying real-time data;
interactive visualization tools for displaying dynamic graphs linked to blockchain-validated data;
a recommendation engine that uses AI to propose remediation actions for flagged issues; and
exportable audit logs that comply with regulatory standards.

16. The system of claim 9, further comprising a multi-layered data validation system including:
an AI engine to preprocess and validate data inputs from multiple sources;
a blockchain infrastructure to immutably store validated data; and
an audit module that provides traceability and verification of all data entries.

17. The system of claim 9, further comprising a token system for incentivizing validated effort, including:
an AI-based validation module that ensures tokens are issued for genuine contributions;
a blockchain ledger to record the issuance, redemption, and transfer of tokens;
a mechanism for linking tokens to real-world assets to provide intrinsic value; and
a decay engine that adjusts token value over time based on user activity or inactivity.

18. The system of claim 9, wherein the BlockSiFr Session Protocol includes:
initiating a session using a quantum-resistant handshake protocol;
dynamically authenticating the session based on continuous user activity monitoring;
adjusting session privileges in real-time based on effort scores and risk assessments; and
immutably logging session metadata on the blockchain for audit purposes.

19. The system of claim 9, further comprising:
IoT devices and RFID sensors configured to capture product movement and environmental data;
an AI-powered provenance analysis engine that uses graph neural networks to verify product origins; and
smart contracts configured to automate workflows based on blockchain-validated data.

20. The system of claim 9, wherein the quantum-resistant cryptography implemented by the blockchain layer comprises:
lattice-based cryptographic algorithms for key exchange and digital signatures;
hash-based cryptographic schemes for message authentication;
multivariate polynomial cryptosystems for encryption; and
a hybrid cryptographic approach combining multiple quantum-resistant techniques to enhance overall security.
